(19) United States
(12) Patent Application Publication
(10) Pub. No.: US 2009/0173287 A1
(43) Pub. Date: Jul. 9, 2009

(54) Combing device

(76) Inventor: Huo-Pia Wang, Chang-Hua City (TW)

Correspondence Address: K&L Gates LLP, STATE STREET FINANCIAL CENTER, One Lincoln Street, BOSTON, MA, 02111-2950, US

(21) Appl. No.: 12/006,600

(22) Filed: Jan. 4, 2008

(51) Int. Cl. A01K 13/00

(52) U.S. Cl. 119/625

(57) ABSTRACT

A combing device includes a combing member and a flexible member. The combing member includes a row of flexibly interconnected comb teeth, each having a combing portion and a butt portion opposite to the combing portion. The butt portions of an adjacent pair of the comb teeth are spaced apart from each other. The flexible member encloses the butt portions of the comb teeth of the combing member, and is formed with a plurality of hollow portions. Each of the hollow portions is disposed between the butt portions of a corresponding adjacent pair of the comb teeth. The combing portions of the comb teeth are exposed from the flexible member.

### BACKGROUND OF THE INVENTION

1. Field of the Invention

The invention relates to a combing device, more particularly to a flexible combing device.

2. Description of the Related Art

As shown in FIG. 1 and FIG. 2, a conventional combing device 1 is used for a large domesticated animal, e.g., a horse or a large dog, and includes a metal combing plate 11 and a handle 12 coupled to the combing plate 11. The combing plate 11 is formed with a plurality of comb teeth 111 at one side thereof. The handle 12 includes first and second handle portions 121, 122 that are respectively coupled to opposite ends of the combing plate 11, and that are coupled removably to each other.

The handle 12 is held by a user to comb a large domesticated animal's hair with the comb teeth 111 of the combing plate 11 so as to remove water from the animal's hair. The combing plate 11 is bent when the first and second handle portions 121, 122 are coupled to each other, resulting in a reduced operating area of the conventional combing device 1. On the other hand, a larger operating area is achieved when the first and second handle portions 121, 122 are decoupled from each other.

Although the conventional combing device 1 facilitates applications of different operating area sizes, flexibility is not provided for facilitating applications to smaller animals, such as small cats and dogs that have bodies with rapidly varying curves. Consequently, when the conventional combing device 1 is used on a smaller pet animal, only a few of the comb teeth 111 will be effective, thereby creating discomfort in the animal.

### SUMMARY OF THE INVENTION

Therefore, the object of the present invention is to provide a combing device that can be used on animals with different sizes and that eliminates discomfort in the animals.

According to the present invention, there is provided a combing device that includes a combing member and a flexible member. The combing member includes a row of flexibly interconnected comb teeth, each having a combing portion and a butt portion opposite to the combing portion. The butt portions of an adjacent pair of the comb teeth are spaced apart from each other. The flexible member encloses the butt portions of the comb teeth of the combing member, and is formed with a plurality of hollow portions. Each of the hollow portions is disposed between the butt portions of a corresponding adjacent pair of the comb teeth. The combing portions of the comb teeth are exposed from the flexible member.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view illustrating a conventional combing device when first and second handle portions of a handle are coupled to each other;

FIG. 2 is another perspective view illustrating the conventional combing device when the first and second handle portions are decoupled from each other;

FIG. 3 is an exploded perspective view of the first preferred embodiment of a combing device according to the present invention;

FIG. 4 is a sectional view of the first preferred embodiment;

FIG. 5 is a sectional view of the first preferred embodiment taken along line V-V in FIG. 4;

FIG. 6 is a sectional view of the first preferred embodiment taken along line VI-VI in FIG. 4;

FIG. 7 is a sectional view of the first preferred embodiment taken along line VII-VII in FIG. 4;

FIG. 8 is a sectional view of the first preferred embodiment taken along line VIII-VIII in FIG. 4;

FIG. 9 is a sectional view similar to FIG. 4, illustrating state of the combing device upon application of an external force; and

FIG. 10 is a sectional view of the second preferred embodiment of a combing device according to the present invention.

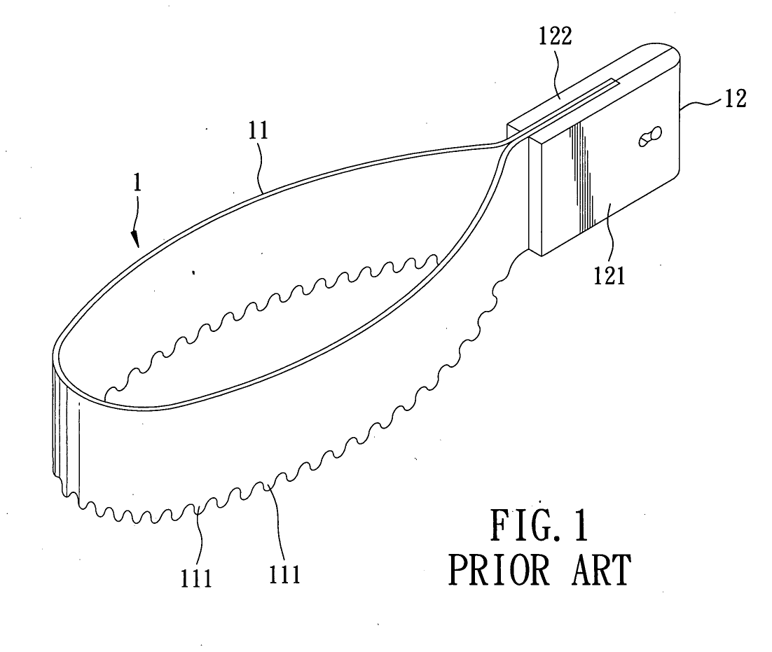

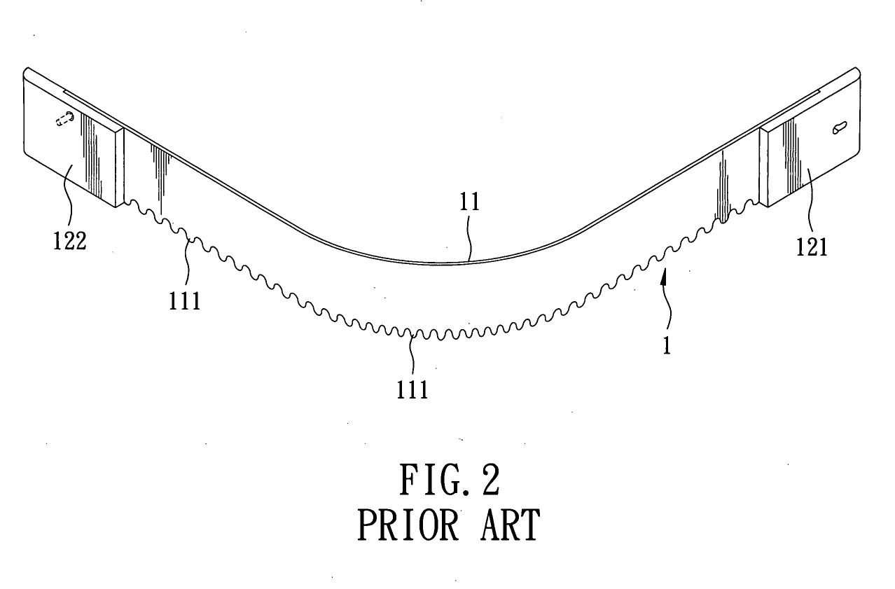

### DETAILED DESCRIPTION OF THE PREFERRED EMBODIMENTS

Before the present invention is described in greater detail, it should be noted that like elements are denoted by the same reference numerals throughout the disclosure.

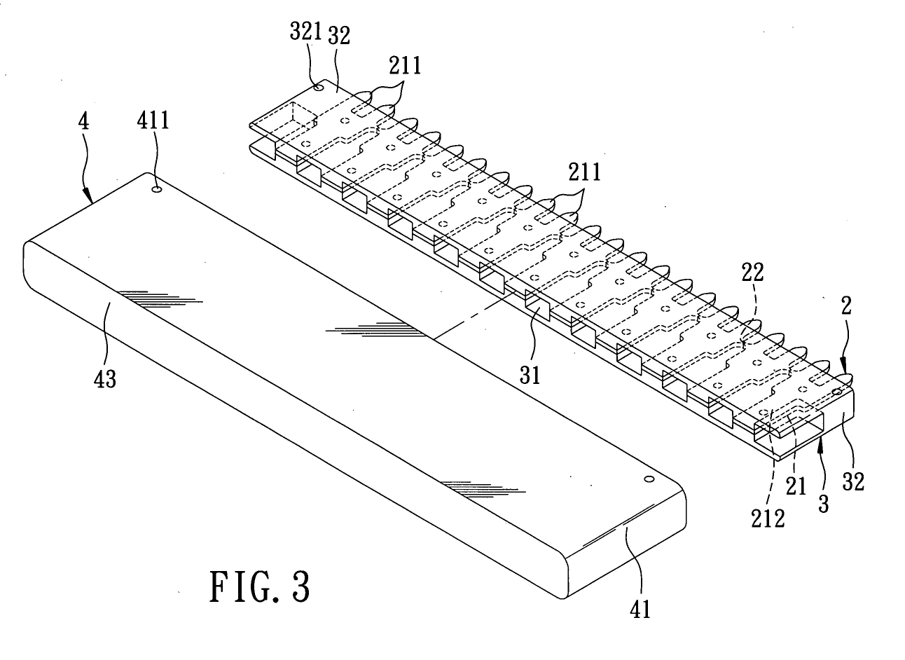

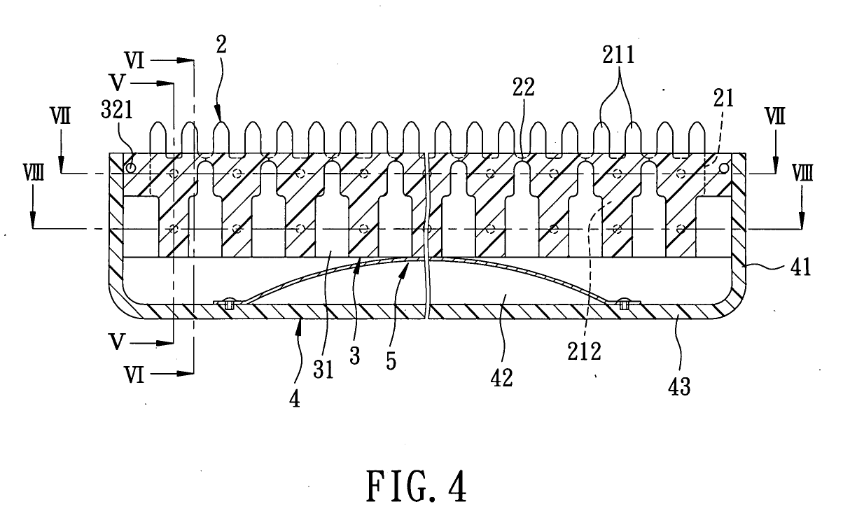

As shown in FIG. 3 and FIG. 4, the first preferred embodiment of a combing device according to the present invention includes a combing member 2, a flexible member 3, a grip member 4, and a biasing unit 5.

The combing member 2 includes a row of flexibly interconnected comb teeth 21, each having a combing portion 211 and a butt portion 212 opposite to the combing portion 211. The butt portions 212 of an adjacent pair of the comb teeth 21 are spaced apart from each other. The combing member 2 further includes a plurality of connecting tabs 22, each of which is disposed between the combing portion 211 and the butt portion 212 of a corresponding one of the comb teeth 21, and interconnects flexibly a corresponding adjacent pair of the comb teeth 21. In this embodiment, the combing member 2 is made from metal.

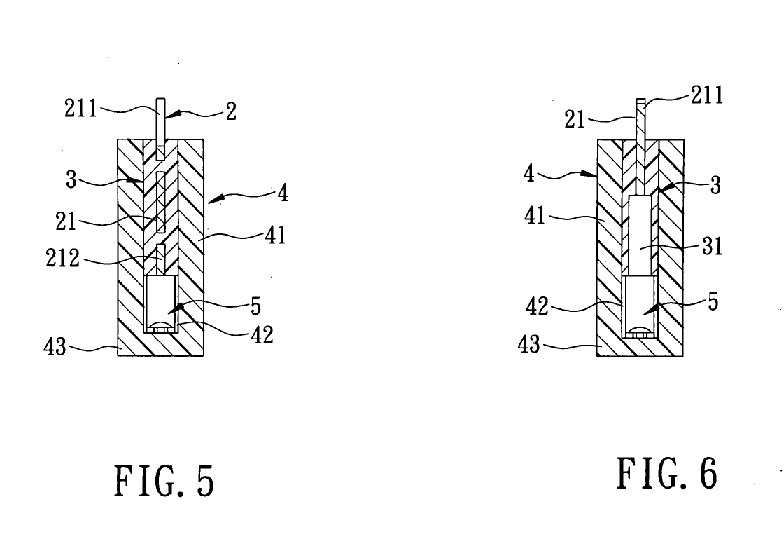

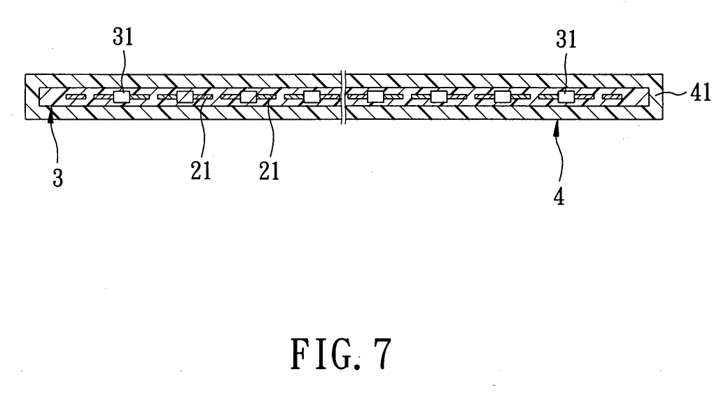

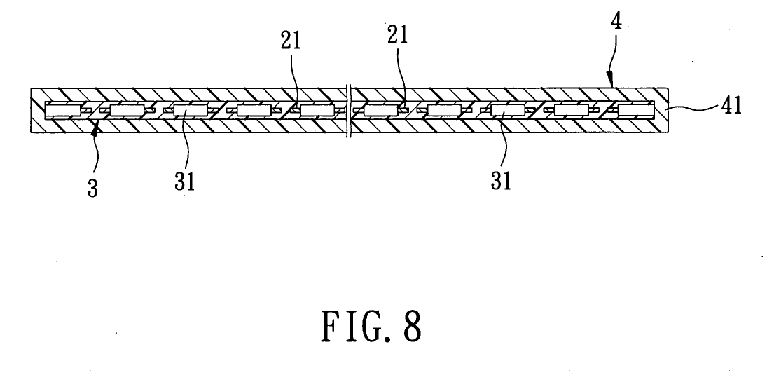

With reference to FIGS. 4 to 8, the flexible member 3 encloses the butt portions 212 of the comb teeth 21 of the combing member 2, and is formed with a plurality of hollow portions 31. Each of the hollow portions 31 is disposed between the butt portions 212 of a corresponding adjacent pair of the comb teeth 21. The combing portions 211 of the comb teeth 21 are exposed from the flexible member 3. In this embodiment, the flexible member 3 is made from plastic.

The grip member 4 is coupled to the flexible member 3, and includes a surrounding wall 41 that defines a receiving space 42, and an end wall 43 for closing one side of the surrounding wall 41. The flexible member 3 is received in the receiving space 42 such that the combing portions 211 of the comb teeth 21 extend outwardly of the receiving space 42. In this embodiment, the flexible member 3 has end blocks 32 engaging the surrounding wall 41 of the grip member 4. In particular, each of the end blocks 32 is formed with a first rivet hole 321, and the surrounding wall 41 of the grip member 4 is formed with second rivet holes 411 that are respectively registered with the first rivet holes 321 in the end blocks 32. During assembly of the combing device, rivet fasteners (not shown) are used to extend through the first and second rivet holes 321, 411 and engage the end blocks 32 to the surrounding wall 41 after the flexible member 3 is received in the receiving space 42.

The biasing unit 5 is disposed in the receiving space 42 between the end wall 43 of the grip member 4 and the flexible member 3. In this embodiment, the biasing unit 5 includes a curved spring plate.

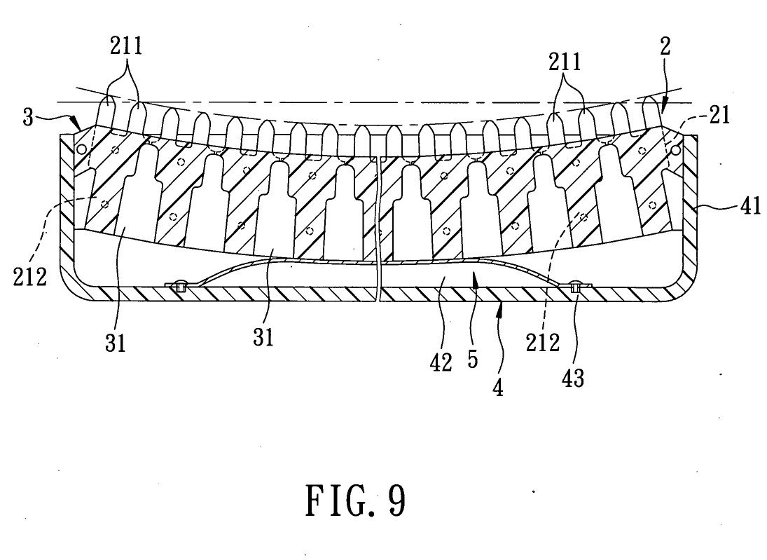

As shown in FIG. 4 and FIG. 9, the grip member 4 is held by a user to comb an animal's hair with the combing member 2. Since the combing portions 211 of each adjacent pair of the comb teeth 21 are connected flexibly to each other via a corresponding one of the connecting tabs 22, and since the hollow portions 31 in the flexible member 3 provide for bend allowance, the comb teeth 21 are movable relative to the grip member 4 along with deformation of the flexible member 3. In particular, the combing portion 211 of each of the comb teeth 21 is displaceable from an original position relative to the grip member 4 toward the end wall 43 of the grip member 4 upon application of an external force to deform the flexible member 3 against biasing action of the biasing unit 5. Consequently, the combing portions 211 of the comb teeth 21 are displaceable according to curves of an animal's body using the combing device of this invention. A restoring force is stored in the biasing unit 5 for restoring the combing portion 211 back to the original position upon removal of the applied external force.

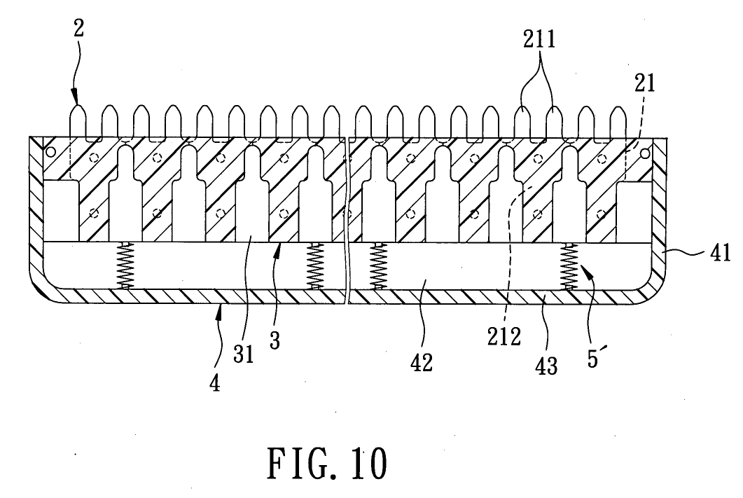

As shown in FIG. 10, the second preferred embodiment of a combing device according to the present invention differs from the first preferred embodiment in that the biasing unit 5′ of the second preferred embodiment includes a plurality of coil springs. Since the effect achieved by the biasing unit 5′ is identical to that disclosed hereinabove with reference to the biasing unit 5 of the first preferred embodiment, further details of the same are omitted herein for the sake of brevity.

In sum, the combing device of the present invention has the following effects and advantages:

With the flexible member 3 enclosing the butt portions 212 of the comb teeth 21 of the combing member 2 such that the comb teeth 21 are movable along with the flexible member 3, while the flexible member 3 is provided with the hollow portions 31 that are each disposed between the butt portions 212 of the corresponding adjacent pair of the comb teeth 21, the combing portion 211 of each of the comb teeth 21 is displaceable from the original position relative to the grip member 4 toward the end wall 43 of the grip member 4 upon application of an external force to deform the flexible member 3 against biasing action of the biasing unit 5 (5′). Consequently, the combing portions 211 of most of the comb teeth 21 are simultaneously effective when using the combing device to comb an animal's hair, thereby increasing combing effectiveness and ensuring comfort of the animal.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A combing device comprising:
a combing member that includes a row of flexibly interconnected comb teeth, each having a combing portion and a butt portion opposite to said combing portion, said butt portions of an adjacent pair of said comb teeth being spaced apart from each other; and
a flexible member that encloses said butt portions of said comb teeth of said combing member, and that is formed with a plurality of hollow portions, each of said hollow portions being disposed between said butt portions of a corresponding adjacent pair of said comb teeth, said combing portions of said comb teeth being exposed from said flexible member.

2. The combing device as claimed in claim 1, wherein said combing member further includes a plurality of connecting tabs, each of which is disposed between said combing portion and said butt portion of a corresponding one of said comb teeth, and interconnects flexibly a corresponding adjacent pair of said comb teeth.

3. The combing device as claimed in claim 1, further comprising a grip member coupled to said flexible member.

4. The combing device as claimed in claim 3, wherein said grip member includes a surrounding wall that defines a receiving space, and an end wall for closing one side of said surrounding wall, said flexible member being received in said receiving space such that said combing portions of said comb teeth extend outwardly of said receiving space.

5. The combing device as claimed in claim 4, wherein said flexible member has end blocks engaging said surrounding wall of said grip member.

6. The combing device as claimed in claim 5, wherein said end blocks engage said surrounding wall of said grip member via rivet fasteners.

7. The combing device as claimed in claim 4, further comprising a biasing unit disposed in said receiving space between said end wall of said grip member and said flexible member.

8. The combing device as claimed in claim 7, wherein said biasing unit includes a curved spring plate.

9. The combing device as claimed in claim 7, wherein said biasing unit includes a plurality of coil springs.

10. The combing device as claimed in claim 1, wherein said combing member is made from metal, and said flexible member is made from plastic.

11. The combing device as claimed in claim 7, wherein said combing portion of each of said comb teeth is displaceable from an original position relative to said grip member toward said end wall of said grip member upon application of an external force to deform said flexible member against biasing action of said biasing unit.
